(19) United States
(12) Patent Application Publication
(10) Pub. No.: US 2011/0298834 A1
(43) Pub. Date: Dec. 8, 2011

(54) APPARATUS AND METHOD FOR CONTROLLING BACK LIGHT

(75) Inventor: Junho SHIN, Seoul (KR)

(73) Assignee: LG ELECTRONICS INC., Seoul (KR)

(21) Appl. No.: 12/900,116

(22) Filed: Oct. 7, 2010

(30) Foreign Application Priority Data
Jun. 7, 2010 (KR) 10-2010-0053513

(51) Int. Cl. G09G 5/10

(52) U.S. Cl. 345/690

(57) ABSTRACT

Disclosed herein is a backlight control apparatus, including an LED backlight drive unit driving an LED backlight module and a control unit outputting an enable signal deterministic of whether to drive the LED backlight drive unit or not to the LED backlight drive unit, and stepwisely decreasing or increasing the duty ratio of a PWM control signal to control the brightness of the LED backlight module and outputting it to the LED backlight drive unit.

### CROSS-REFERENCE TO RELATED APPLICATIONS

Pursuant to 35 U.S.C. §119(a), this application claims the benefit of earlier filing date and right of priority to Korean Application No. 10-2010-0053513, filed on Jun. 7, 2010, the contents of which are hereby incorporated by reference herein in their entirety.

### BACKGROUND OF THE INVENTION

1. Field of the Invention

The present invention relates to a back light control apparatus controlling an enable signal and a PWM control signal inputted to an LED backlight drive unit in a case an LED backlight turns on, and a control method thereof.

2. Description of the Related Art

A liquid crystal display (LCD) device is one of flat panel display devices displaying images using liquid crystal. Because a liquid crystal display panel is a light receiving device incapable of self-lighting, the liquid crystal display device requires the construction of a backlight unit supplying for separate lights. The backlight unit may have a light source such as a CCFL (Cold Cathode Fluorescent Lamp) or an LED (Light Emitting Diode).

Because an LED is superior in color reproducibility to a CCFL, having a high response speed and an impact resistant, and may arbitrarily change the light luminance and the color temperature, through control of a current flowing in a red LED, a green LED and a blue LED, it is widely used as a light source of a backlight unit, for example, a recent liquid crystal display device.

With regard to drive apparatus of an LED, an apparatus capable of obtaining a high contrast screen through local drive of an LED has been developed. In particular, by finding a bright portion and a dark portion through an input signal of a screen, brightness of an LED would be adjusted to the LED using such information and using a PWM (Pulse Width Modulation).

In a case a drive start signal from exterior is provided in an enable state, a conventional LED drive apparatus radiates an LED at a targeted luminance by abruptly changing a duty ratio of a PWM control signal from 0% to a duty ratio corresponding to the target luminance. An abrupt change in the duty ratio of a PWM control signal leads to change in current instantly flowing in the LED, and such an abrupt change in current causing an instant change from black luminance to target luminance could be observed. Also, there is a problem that does damage to devices, for example transistors, because an over-current through an LED drive apparatus flows due to an abrupt current change.

### SUMMARY OF THE INVENTION

The invention devised to solve the aforementioned problem, the present invention takes it an object to provide a backlight control method and a control method thereof capable of a soft start by controlling all of an enable signal and a PWM control signal inputted to the LED backlight drive unit, in a case to an LED backlight on.

To achieve the above-mentioned object, a backlight control apparatus according to one embodiment of the present invention includes an LED (Light Emitting Diode) backlight drive unit driving an LED backlight module and a control unit outputting an enable signal to determine whether to drive the LED backlight drive unit or not to the LED backlight drive unit, and outputting a PWM (Pulse Width Modulation) control signal to control the brightness of the LED backlight module to the LED backlight drive unit, wherein the control unit stepwisely decreases the duty ratio of the PWM control signal to set it low and sets the enable signal low to be outputted in a case of turning the LED backlight module off.

According to one aspect of one embodiment of the present invention, the control unit sets the enable signal high to be outputted and stepwisely increases a duty ratio of the PWM control signal in a case of turning the LED backlight module on.

According to one aspect of one embodiment of the present invention, the LED backlight drive unit characteristically includes a signal control unit outputting a drive signal for driving the LED backlight module based on the PWM control signal and a DC-DC converter boosting an input voltage by the drive signal and outputting to the LED backlight module.

A backlight control apparatus according to another embodiment of the present invention includes an LED backlight drive unit driving an LED backlight module and a control unit outputting an enable signal to determine whether to drive the LED backlight drive unit to the LED backlight drive unit, and outputting a PWM control signal to control the brightness of the LED backlight module to the LED backlight drive unit, wherein the control unit sets the control signal high to be outputted and stepwisely increase the PWM control signal duty ratio in a case of turning the LED backlight module on.

According to one aspect of still another embodiment of the present invention, the LED backlight drive unit characteristically includes a signal control unit outputting a drive signal for driving the LED backlight module based on the PWM control signal and a DC-DC converter boosting an input voltage by the drive signal and outputting it to the LED backlight module.

A backlight control method according to one embodiment of the present invention may includes the step of detecting an enable signal value to determine whether to drive an LED backlight drive unit and setting the enable signal high to be outputted to the LED backlight drive unit and decreasing a duty ratio of a PWM control signal stepwisely after a predetermined time elapses from a point the enable signal sets high.

According to one aspect of one embodiment of the present invention, the step of detecting an enable signal value determinative of whether to drive the LED backlight drive unit or not and setting the enable signal high to output it to the LED backlight drive unit is characterized by setting the enable signal high and outputting it to the LED backlight drive unit in a case the detected enable signal value is low and by setting the enable signal low and then set it high and outputting the resultant one to the LED backlight drive unit in a case the detected enable signal value is high.

A backlight control method according to another embodiment of the present invention may include setting a PWM control signal low to turn an LED backlight module off in a case a valid signal has not been inputted for a predetermined time, setting an enable signal low and outputting it to an LED backlight drive unit after a predetermined time elapses from a point the PWM control signal sets low and controlling the enable signal and the PWM control signal to turn the LED backlight module on in a case a valid signal is inputted after the LED backlight module turns off.

According to one aspect of another embodiment of the present invention, the step of setting a PWM control signal low to turn an LED backlight module off in a case a valid signal has not been inputted for a predetermined time is to stepwisely decrease a duty ratio of the PWM control signal to set it low.

According to one aspect of another embodiment of the present invention, the step of controlling the enable signal and the PWM control signal to turn the LED backlight module on in a case a valid signal is inputted after the LED backlight module turns off includes setting the enable signal high to output it to the LED backlight drive unit and increasing a duty ratio of the PWM control signal stepwisely after a predetermined time elapses from a point the enable signal is set high and thus output.

A backlight control method of another embodiment of the present invention may include controlling a PWM control signal and an enable signal to turn an LED backlight module off in a case a valid signal is not inputted for a predetermined time, setting the enable signal high and outputting it to an LED backlight drive unit in a case a valid signal is inputted after the LED backlight module turns off and increasing a duty ratio of the PWM control signal stepwisely after a predetermined time elapses from a point the enable signal is set high and thus output.

### BRIEF DESCRIPTION OF THE DRAWINGS

FIG. 1 is a block diagram showing the construction of a backlight control apparatus according to an exemplary embodiment of the present invention;

FIG. 2 is a timing diagram of an enable signal and a PWM control signal in a backlight control apparatus according to an exemplary embodiment of the present invention; and

FIG. 3 is a flow chart for describing a backlight control method according to an exemplary embodiment of the present invention.

### DETAILED DESCRIPTION OF THE INVENTION

A preferred embodiment according to the present invention will be described in consideration of the accompanying drawings. In the drawings, the same reference number refers to the same or like part.

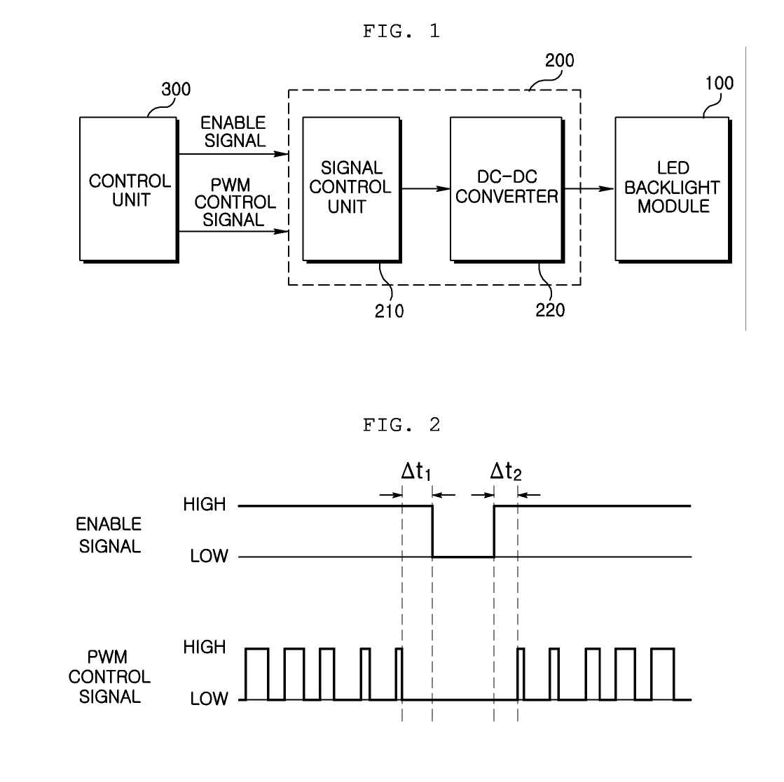

FIG. 1 is a block diagram showing the construction of a backlight control apparatus according to an exemplary embodiment of the present invention.

A backlight control apparatus according to one embodiment of the present invention can be applied to a LCD (Liquid Crystal Display) installed at a monitor, a TV, a laptop, etc., having an LED (Light Emitting Diode) backlight module as a light source employed in a LCD.

Referring to FIG. 1, a backlight control apparatus according to one embodiment of the invention includes an LED backlight module 100, an LED backlight drive unit 200, and a control unit 300.

An LED backlight module 100 includes a plurality of red (R) LEDs, green (G) LEDs and blue (B) LEDs radiating with luminance proportional to a supplied current. An LED backlight module 100 may uses a plurality LEDs of one color. A current flowing into an LED backlight module 100 can be determined by a voltage supplied from the LED backlight drive unit 200 and the resistivity property of an LED backlight module 100. In an LED backlight module 100, a multiple of LED strings, each string formed of the plurality of LEDs arranged in serial, are paralleled connected.

An LED backlight drive unit 200 receives an enable signal from the control unit 300. The enable signal is a signal informing a point when a valid signal is inputted, controlling whether to drive the LED backlight drive unit 200 or not to controllably turn on or off of an LED backlight module 100. In a case an enable signal having a high value is applied, the LED backlight drive unit 200 normally drives an LED backlight module 100 (enable), and in a case an enable signal having a low value is applied, the LED backlight drive unit 200 does not operate (disable) and an LED backlight module 100 turns off to abort a screen display.

The LED backlight drive unit 200 receives a PWM (Pulse Width Modulation) control signal from the control unit 300. The PWM control signal is a signal for controlling the brightness of an LED backlight module 100. The LED backlight drive unit 200 may include a signal control unit 210 and a DC-DC converter 220, and the signal control unit 210 generates a drive signal for driving an LED backlight module 100 based on the PWM control signal inputted from the control unit. In a case an LED backlight drive unit 200 does not operate because the enable signal is set low, the drive signal has a low value. Whereas in a case an enable signal is high, the drive signal becomes a PWM signal having a duty ratio except zero (0).

The DC-DC converter 220 converts an input voltage supplied from a power supply unit (not shown) into a voltage level necessary for driving the LED backlight module 100 based on a drive signal inputted from the signal control unit 210 to provide it to the LED backlight module 100. Generally, because a voltage level needed for driving the LED backlight module 100 is higher than an input voltage, the input voltage is boosted and outputted.

The control unit 300 outputs an enable signal controlling whether to drive an LED backlight drive unit 200 or not to drive the LED backlight drive unit 200, and stepwisely decreases or increases the duty ratio of the PWM control signal for controlling the brightness of the LED backlight module 100 and outputs it to the LED backlight drive unit 200.

An enable signal outputted by the control unit 300 is a signal informing a point when a valid signal exists, controlling whether the LED backlight drive unit 200 will be driven or not to controllably turn the LED backlight module 100 on or off. The LED backlight drive unit 200 normally drives the LED backlight module 100 (enable) in a case the enable signal is high, and the LED backlight drive unit 200 does not operate (disable) to turn the LED backlight module 100 off in a case the enable signal is low.

Also, the control unit 300 outputs a PWM control signal for adjusting the brightness of the LED backlight module 100. In regard to the brightness adjustment of the LED backlight module 100, the control unit 300 outputs a PWM control signal having a duty ratio calculated according to a table stored in a storage unit (not shown) in order to drive the LED backlight module 100 at a required brightness according to an image data input.

In a case an off-state LED backlight module 100 turns on, the control unit 300 performs a soft start action by stepwisely increasing a PWM control signal duty ratio from 0 (zero) and outputting it to the LED backlight drive unit 200, so as to prevent an over-current from flowing into the LED backlight drive unit 200.

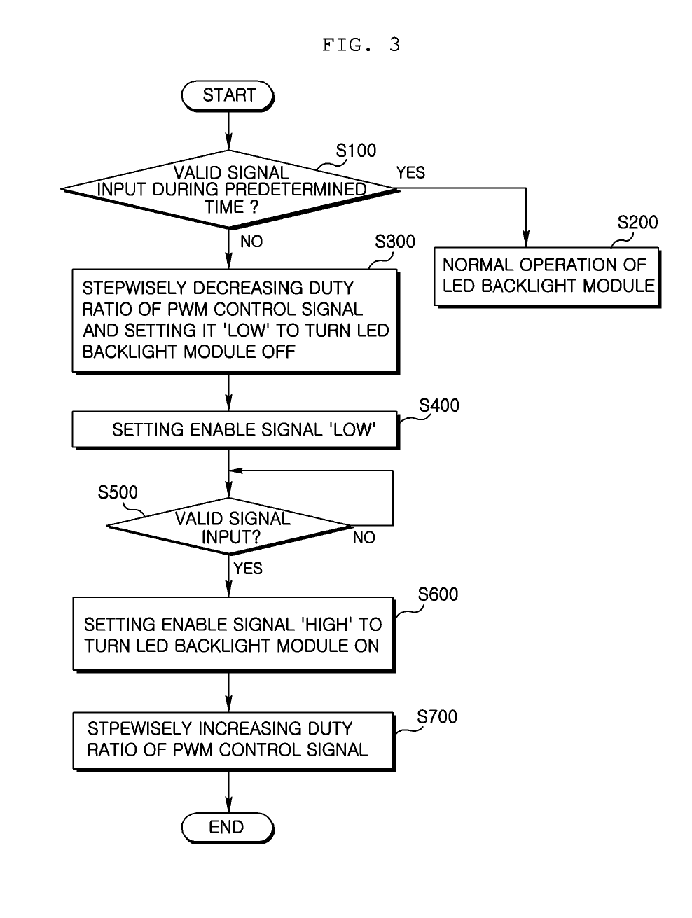

The case an off-state LED backlight module 100 turns on refers to the input of a valid signal, the valid signal input including for example, an instance a user manipulates an OSD (On Screen Display) installed at a liquid crystal display device of a monitor having a backlight control apparatus to input a signal for performing an operation, such as bright adjustment or channel change, and an instance a RGB signal, etc. is inputted. At this time, the control unit 300 should set the enable signal to change from low to high before a point of time when the duty ratio increase of the PWM control signal is started. That is, in a circumstance the PWM control signal is set low and thus a duty ratio is 0%, the control unit 300 first sets the enable signal from low to high to be outputted and after a predetermined time has elapsed from that time, should start to stepwisely increase the duty ratio of the PWM control signal. By performing a control of the enable signal value together besides stepwisely increasing the PWM control signal duty ratio from 0%, a soft start for preventing an over-current flowing into the LED backlight drive unit 200 in a case the LED backlight module 100 turns on may be carried out. In this case, for it is essential that changing the enable signal value from low to high be firstly carried out over starting to increase the PWM control signal duty ratio, the enable signal and the PWM control signal will be described in detail with reference to a timing diagram shown in FIG. 2.

FIG. 2 is a timing diagram of an enable signal and a PWM control signal of a backlight control apparatus according to one embodiment of the present invention.

The control unit 300 outputs two signals to the LED backlight drive unit 200. A first one is referred to as an enable signal, a signal controlling whether to drive the LED backlight drive unit 200 or not to controllably turn the LED backlight module 100 on or off. The other one is referred to as a PWM control signal, a signal controlling the brightness of the LED backlight module 100.

In a case the enable signal is high, the LED backlight drive unit 200 normally drives the LED backlight module 100. In a case the enable signal is low, the LED backlight drive unit 200 does not operate and the LED backlight module 100 turns off to abort a screen display.

The PWM control signal has a duty ratio calculated based on a table stored in a storage unit (not shown) in order to drive the LED backlight module 100 at a brightness required according to an input image data. The PWM control signal is inputted to the signal control unit 210, herein the signal control unit 210 generates a drive signal for driving the LED backlight module 100 based on the PWM control signal.

In particular, in a case the LED backlight module 100 turns on, a backlight control apparatus according to the present invention is intended to perform a soft start operation by prohibiting an overcurrent from flowing into the LED backlight drive unit 200. In regard to this, a control of the enable signal and the PWM control signal is needed.

Referring to FIG. 2, the PWM control signal is set to have a duty ratio configured to drive an LED backlight module 100 at a brightness required based on an input image data. At this time, an LED backlight drive unit 200 and the LED backlight module 100 operate as a normal operation mode, and an enable signal reasonably has a high value. As described above, in a case for a manipulation and a command necessary for an action performance are not inputted during a predetermined time, a monitor enters into a sleep mode and its screen becomes full black, the LED backlight module 100 turns off. When the LED backlight module 100 turns off, a control unit 300 stepwisely decreases the duty ratio of the PWM control signal down to 0%.

In a state an LED backlight module 100 is off, when the LED backlight module 100 turns on according to the input of a RGB signal or the like, a control of an enable signal is initially needed for a soft start operation.

In a case the LED backlight module 100 remains off, a duty ratio of the PWM control signal becomes 0% and the PWM control signal set low. In order to turn the LED backlight module 100 on again, the control unit 300 needs to increase the duty ratio of the PWM control signal stepwisely. Herein, for a soft start, it is necessary to set the enable signal from low to high before the duty ratio increase of the PWM control signal is started. That is, an enable signal should be changed from low to high prior to a predetermined time interval (Δt₂) with respect to a moment that a duty ratio of the PWM control signal stepwisely increases at the point of 0%. Here, Δt₂ may be pre-set in the manufacture of a liquid crystal display device such as monitors.

For a control of such an enable signal, it is necessary to set the enable signal from high to low after the LED backlight module 100 turns off and the PWM control signal duty ratio becomes 0%. That is, after a predetermined time (Δt₁) has elapsed starting from a point when the duty ratio of the PWM control signal attains at 0%, the control unit 300 sets the high-set enable signal into low. Here, Δt₁ may be pre-set in the manufacture of a liquid crystal display device such as monitors. As such, by setting an enable signal low, it may be set that an enable signal changes from low to high prior to a point when the PWM control signal has a non-zero duty ratio in a case the LED backlight module 100 turns on.

To perform a soft start action when the LED backlight module 100 turns on, the control unit 300 has only to set the enable signal into low at earlier than a point when the enable signal changes into high, and a time interval the enable signal remains in a low state is unrelated to such a soft start action. Thus, as described above, an enable signal may be set low in Δt₁ elapsed time from a point an LED backlight module 100 turns off and the PWM control signal duty ratio becomes 0%, or the enable signal may be set low prior to a predetermined time interval from a point of changing the enable signal into high.

That is, in a case of turning an LED backlight module 100 on such that an LED backlight drive unit 200 normally drives the LED backlight module 100, a soft start may be realized by setting the enable signal from low into high before stepwisely increasing a PWM control signal duty ratio having a 0% duty ratio due to the off of the LED backlight module 100.

FIG. 3 is a flow chart for describing a backlight control method according to one embodiment of the present invention.

In describing a control method according to the present invention, it is assumed that the LED backlight module 100 is in a normal operation state, not turning off. Because the LED backlight module 100 and the LED backlight drive unit 200 are in a normal drive state, an enable signal is set high. Also, a control unit 300 outputs a PWM control signal having more than 0% duty ratio to the LED backlight drive unit 200 in order to drive the LED backlight module 100 at a required brightness based on an input image data.

Referring to FIG. 3, in a state the LED backlight module 100 is on as such, it is determined that a valid signal has been input during a predetermined time (S100). The valid signal may include a signal input for performing an operation such as a bright adjustment or a channel change by manipulating, by a user, an OSD (On Screen Display) provided on a liquid crystal display device, for example a monitor, having a backlight control apparatus according to the present invention. Alternatively, a case a RGB or the like is input may be available.

In a case the valid signal is inputted at least one time during a predetermined time, the LED backlight module 100 maintains its normal operation (S200). That is, the control unit 300 maintains the setting of an enable signal high, and adjusts a duty ratio of the PWM control signal according to the valid signal to output the resulting one to the LED backlight drive unit 200. The predetermined time may be set in the manufacture of a liquid crystal display device such as monitors, or it may be differently set by a user's need.

If there is no valid signal input during the predetermined time, the LED backlight module 100 turns off. In a case the LED backlight module 100 turns off, the control unit 300 controls an enable signal and a PWM control signal both. That is, first by stepwisely decreasing a PWM control signal duty ratio finally down to 0%, the PWM control signal is set low (S300). Next, a high-set enable signal is set to low and it is output to an LED backlight drive unit 200 (S400).

A control unit 300 continuously determines if there is a valid signal input after the LED backlight module 100 turns off (S500).

In a case a valid signal is not inputted for some time during the predetermined time, a control unit 300 maintains a low-set enable signal and a PWM control signal setting having a 0% duty ratio, and the LED backlight module 100 remains in an off state.

When a valid signal is inputted, the LED backlight module 100 turns on. In a case of turning the LED backlight module on, the control unit 300 controls all of an enable signal and a PWM control signal to perform a soft start action. That is, first a low-set enable signal is set to high and it is outputted to the LED backlight drive unit 200 (S600). Next, a duty ratio of the PWM control signal stepwisely increases from 0% (S700). As described above, because a duty ratio of the PWM control signal is defined to start increasing after the enable signal is set high, a duty ratio of the PWM control signal duty ratio should increase after a predetermined time has elapsed from a point the enable signal is set high. The control unit 300 continuously adjusts a PWM control signal duty ratio according to an input valid signal to control the brightness of LED backlight module 100.

While embodiments of the present invention have been described in the previous section, it would be understood to those skilled in the art that an embodiment employing various changes and equivalents can be made thereof. Thus, the scope of the present invention protection should be defined by the following claims and the following equivalents.

What is claimed is:

1. A backlight control apparatus, comprising:
an LED (Light Emitting Diode) backlight drive unit driving an LED backlight module; and
a control unit outputting an enable signal to determine whether to drive the LED backlight drive unit or not to the LED backlight drive unit, and outputting a PWM (Pulse Width Modulation) control signal to control the brightness of the LED backlight module to the LED backlight drive unit,
wherein the control unit stepwisely decreases the duty ratio of the PWM control signal to set it low and sets the enable signal low to be outputted after the PWM control signal to set it low in a case of turning the LED backlight module off.

2. The backlight control apparatus according to claim 1, wherein the control unit sets the enable signal high to be outputted and stepwisely increases a duty ratio of the PWM control signal after the enable signal to set it high in a case of turning the LED backlight module on.

3. The backlight control apparatus according to claim 1, wherein the LED backlight drive unit includes:
a signal control unit outputting a drive signal for driving the LED backlight module based on the PWM control signal; and
a DC-DC converter boosting an input voltage by the drive signal and outputting to the LED backlight module.

4. A backlight control apparatus, comprising:
an LED backlight drive unit driving an LED backlight module; and
a control unit outputting an enable signal to determine whether to drive the LED backlight drive unit to the LED backlight drive unit, and outputting a PWM control signal to control the brightness of the LED backlight module to the LED backlight drive unit,
wherein the control unit sets the enable signal high to be outputted and stepwisely increase the PWM control signal duty ratio after the enable signal to set it high in a case of turning the LED backlight module on.

5. The backlight control apparatus according to claim 4, wherein the LED backlight drive unit includes:
a signal control unit outputting a drive signal for driving the LED backlight module based on the PWM control signal; and
a DC-DC converter boosting an input voltage by the drive signal and outputting it to the LED backlight module.

6. A backlight control method, comprising:
detecting an enable signal value to determine whether to drive an LED backlight drive unit and setting the enable signal high to be outputted to the LED backlight drive unit; and
decreasing a duty ratio of a PWM control signal stepwisely after a predetermined time elapses from a point the enable signal sets high.

7. The backlight control method according to claim 6, wherein detecting an enable signal value deterministic of whether to drive an LED backlight drive unit and setting the enable signal high to output it to the LED backlight drive unit is to:
set the enable signal high to output it to the LED backlight drive unit in a case the detected enable signal value is low; and
set the enable signal low and then set it high and output the resultant one to the LED backlight drive unit in a case the detected enable signal value is high.

8. A backlight control method, comprising:
setting a PWM control signal low to turn an LED backlight module off in a case a valid signal has not been inputted for a predetermined time;
setting an enable signal low and outputting it to an LED backlight drive unit after a predetermined time elapses from a point the PWM control signal sets low; and
controlling the enable signal and the PWM control signal to turn the LED backlight module on in a case a valid signal is inputted after the LED backlight module turns off.

9. The backlight control method according to 8, wherein setting a PWM control signal low to turn an LED backlight module off in a case a valid signal has not been inputted for a predetermined time is to stepwisely decrease a duty ratio of the PWM control signal to set it low.

10. The backlight control method according to 8, wherein controlling the enable signal and the PWM control signal to turn the LED backlight module on in a case a valid signal is inputted after the LED backlight module turns off includes:
setting the enable signal high to output it to the LED backlight drive unit; and
increasing a duty ratio of the PWM control signal stepwisely after a predetermined time elapses from a point the enable signal is set high and thus output.

11. A backlight control method, comprising:
controlling a PWM control signal and an enable signal to turn an LED backlight module off in a case a valid signal is not inputted for a predetermined time;
setting the enable signal high and outputting it to an LED backlight drive unit in a case a valid signal is inputted after the LED backlight module turns off; and
increasing a duty ratio of the PWM control signal stepwisely after a predetermined time elapses from a point the enable signal is set high and thus output.
